(19) United States
(12) Patent Application Publication
(10) Pub. No.: US 2024/0144412 A1
(43) Pub. Date: May 2, 2024

(54) SYSTEM AND METHOD FOR THE PROMOTION OF MOBILITY SERVICES AND LOGISTICS OF GOODS BASED ON ADVERTISEMENT

(71) Applicant: DOPLLER, S DE RL DE CV, Nuevo Leon (MX)

(72) Inventors: Ian Leo Wolff Westrup, Nuevo Leon (MX); Jorge Eduardo Cordova Mireles, Nuevo Leon (MX)

(73) Assignee: DOPLLER, S DE RL DE CV, Nuevo Leon (MX)

(21) Appl. No.: 18/390,308

(22) Filed: Dec. 20, 2023

Related U.S. Application Data
(63) Continuation of application No. 17/460,661, filed on Aug. 30, 2021.

(51) Int. Cl. G06Q 50/40; G06F 9/54; G06F 16/22; G06F 16/29; G06F 16/9535; G06Q 20/08; G06Q 30/018; G06Q 30/0241; G06Q 30/0251; G06Q 30/0273; G06Q 30/0283; G06Q 50/26; H04W 4/35; H04W 4/40

(52) U.S. Cl. CPC G06Q 50/40; G06F 9/547; G06F 16/22; G06F 16/29; G06F 16/9535; G06Q 20/085; G06Q 30/018; G06Q 30/0253; G06Q 30/0261; G06Q 30/0264; G06Q 30/0269; G06Q 30/0273; G06Q 30/0277; G06Q 30/0284; G06Q 50/265; H04W 4/35; H04W 4/40; G06Q 30/0282

(57) ABSTRACT

System and method for promoting mobility and logistics of goods services based on advertisements. The system allows the user to be given the freedom to choose and hire the service and the price of the service they want, based on a series of advertisements that promote the services of the drivers before an audience of potential customers generated by an operating system to show the offer of the drivers, of their services of transport of people and/or logistics and delivery of goods. The customers create their own community of favorite and trusted drivers to more easily hire that community of drivers when a service is required. The driver and the customer can agree on special and fixed prices between both parties so that the customer can hire their favorite and trusted drivers on a regular basis with the certainty that the prices are those agreed between both parties.

### CROSS REFERENCE TO RELATED APPLICATION

This application is a continuation of U.S. patent application Ser. No. 17/460,661 filed on Aug. 30, 2021, titled “SYSTEM AND METHOD FOR THE PROMOTION OF MOBILITY SERVICES AND LOGISTICS OF GOODS BASED ON ADVERTISEMENT”, which claims priority to Mexican Patent Application No. MX/a/2021/007255 filed on Jun. 17, 2021, both of which are herein incorporated by reference in their entirety.

### BACKGROUND OF THE INVENTION

### Object of the Invention

The object of the present invention is to provide a system and method for the promotion of mobility services and logistics of goods based on advertisements that potential customers observe or receive, promoting the existence of a free market, improving security, the quality of services and competitiveness.

### FIELD OF THE INVENTION

The present invention belongs to the technical field of data processing methods or systems specially adapted for transport and/or communication purposes.

### DESCRIPTION OF THE RELATED ART

In recent years, mobility applications have had an important peak, since they offer users greater security and a better cost-benefit ratio, in addition to allowing them to control aspects of the trip such as the route to take and the estimated time of arrival.

Regarding the state of the art, several inventions were found, such as the one described in document number MX/a/2018/013740, which is based on a system and methods for monitoring the driver's behavior for the management of vehicle fleets in a fleet of vehicles using an imaging device in front of the driver. The system and methods described in the mentioned document refer, in general, to the management of vehicular fleets to increase the safety of the fleet and improve the performance of the drivers of the fleet, additionally it refers to the monitoring of the operation of the vehicles of the fleet using one or more image devices in front of the drivers, it is located in the fleet vehicles to record the activities of the fleet drivers and their passengers, and stores the information related to the monitored activities, selectively generating warnings related to the monitored activities, and reporting the monitored activities to a central fleet management system for use in increasing the safety of fleet vehicles and to help improve the drivers performance.

Similarly, the invention in document MX/a/2016/004246 refers to a method and a device to order a taxi. The method includes: determining whether a user requires to order a taxi based on at least some usual behavior data and time data; and when it is determined that the user requires to order a taxi, generate and send a taxi request order. In the mentioned invention, the terminal device can automatically generate and send a taxi request command when it determines that the user requires to order a taxi. In this way, a taxi request service can be started as soon as possible, and thus avoid delaying the user's schedule. Furthermore, the process does not require user interference. Thus, the operation of the user can be simplified and time saved for the user.

On the other hand, document number MX/a/2019/002003 refers to a device for controlling moving objects, a method for controlling moving objects, and a moving object that makes it possible to correctly drive an object in motion according to a person who stands on the moving object or a candidate for it and a person getting off the moving object or a candidate for it. The moving object control apparatus includes a driving control unit that performs, based on the recognition of at least one of the candidates to get on the moving object or a candidate to get off the moving object, the control of acceleration/deceleration of the moving object. The described technology is applicable to, for example, a moving object such as a bus and a taxi, or a control apparatus that controls the automatic driving or the semi-automatic driving of the moving object.

Likewise, the document number MX/a/2007/013317 can be used to operate Public Transportation in an orderly and efficient manner PARTS OF THE INVENTION. The invention consists of 2 parts: 1.1 APPARATUS to operate Public Transport; 1.1.1 OPTIMAL APPARATUS to operate Public Transport, which is mounted on each of the vehicles that make it up and which has all the elements to operate the METHOD the best way; 1.1.2 MINIMUM APPARATUS to operate Public Transport, which is mounted on each of the vehicles that comprise it and which has the minimum elements to operate the METHOD properly; 1.1.3 INTERMEDIATE APPARATUS, which does not have the components of the OPTIMAL but it has more components than the minimum; 1.2 METHOD to operate Public Transport that solves the different phases of the Public Transport process: 1. Start of the driver, 2. Start of the trip, 3. During the trip, 4. End of the trip, 5. Term of the driver, 6. Out of service, 7. In service, 8. Any time from the vehicle, 9. Any time from an Authorized Telephone Number, and 10. At any time from the Call Center 2. CONTROL LEVELS It allows to control, monitor, analyze and use Public Transport at different levels: 1. Traffic and Highway Authorities (optional), 2. Tax Authorities (optional), 3. Drivers, 4. Concessionaires, 5. Passengers, 6. Authorized Telephone Numbers, 7. Call Center, 3. BENEFITS: 3.1 General, 3.1.1 Provides a means for both the Passenger, and the Driver to ask for help in case of panic. 3.1.2 It significantly improves the circulation of vehicles, preventing public transport from being the source of chaos; 3.2. Traffic and Highway Authorities; 3.2.1 Provides a means of surveillance and control of Public Transport vehicles, to prevent from circulating vehicles that are either unregistered or that their rights are not in force; 3.2.2 Provides a means of surveillance and control of the Drivers of Public Transport, to prevent them from driving if they are not registered or their rights are not in force; 3.2.3 Provides means that allow to give security to passengers of Public Transport; 3.2.4 Provides means to quantify the income of the Driver for the payment of taxes; 3.3 Tax Authorities (tax collectors): 3.3.1 Provides Taxi Drivers with the necessary information about the trips they make so that they can pay taxes properly; 3.3.2 Provides Taxis Passengers with an authorized voucher (invoice), which is safe enough to avoid tax evasion due to apocryphal vouchers issued by Public Transport Drivers; 3.4 Drivers: 3.4.1 Provides protection to the Driver during the trip by providing a means to request help; 3.4.2 Provides a means to request support if assistance is required; 3.4.3 Provides a means to make cell phone calls without getting distracted with the keyboard; 3.4.4 Provides Public Transport Drivers with the means to quantify the cost of their trips by time used and distance traveled; 3.4.5 Educates Drivers on their road behavior through their monitoring and behavior analysis; 3.5 Concessionaires (owners of the concession): 3.5.1 Provides a means of surveillance, control and management of their vehicles; 3.5.2 Provides a means of surveillance, control and management of their Drivers; 3.6 Passengers (citizens): 3.6.1 Provides a method selection of the vehicle before it is boarded; 3.6.2 Provides an optional method to identify and record that the passenger boarded a vehicle; 3.6.3 Provides protection to the Passenger during the trip providing them with a means to ask for help; 3.6.4 Provides an online receipt of the trips made, which is legally valid and can be used as a deduction for the payment of taxes.

Furthermore, there is the invention from document number MX/a/2007/010618, which describes a method and device to provide information on the status of routes and their use; a method for encoding traffic information includes the steps of: generating management information of the message including message identification (ID) information, indicating that the traffic information is status information; generating the status information including traffic status information; generating the georeferenced location information corresponding to the traffic status information and generating a traffic information message including the management information of the message, the status information, and the georeferenced location information; Accordingly, the method provides a vehicle driver who travels along a route of traffic congestion or congested route with real-time traffic status information on the route, such that the vehicle driver can reach the desired destination within the shortest period of time using predicted route traffic information.

Another related invention is the one from document number CN107567606B, which refers to a centralized system for remotely guiding vehicles and a method to guide vehicles remotely automatically and manually. The centralized system includes command, routing and control centers, mobile phone providers, transportation service providers and vehicles. These operations are totally or partially without human intervention. The system is developed by adequately specializing in a mobile radio system that uses some suitable control and safety features to monitor the operation.

Additionally, one other technology found corresponds to the number CN111009114A, an invention that discloses an intelligent programming management system for car rental, a terminal mounted on a vehicle and a communication protocol for the vehicle itself. The system comprises a passenger terminal, a vehicle-mounted terminal, a dispatch management center, and a vehicle communication protocol. Passengers can use phones, computers, smart devices and special devices to order vehicles, and they can also call the vehicles on the roadside, so that the vehicles can be used instantly or reserved by reservation. The dispatch management center dispatches vehicles and dispatches vehicle rental orders by combining weather and traffic information and adopting artificial intelligence and big data technologies, so that the scheduling of empty vehicles is optimized, the distance and time of driving without load reduces operating costs, increases business volume, shortens waiting times for passengers and improves satisfaction. The vehicle-mounted terminal intelligently identifies road-calling passengers, interacts with passengers and drivers, collects and receives vehicle and travel information from it, sends travel information to the vehicle, and ensures the safety of passengers, drivers and vehicles. Vehicles that comply with the vehicle communication protocol are suitable for the system; corresponding vehicles can be conveniently produced and purchased; the system is suitable for manned and unmanned taxis, and it is suitable for the rental of passenger and cargo vehicles.

Similarly, document number CN105575007B describes an invention that refers to the field of car rental management and, in particular, to a method to make consumer users pick up and return a car by themselves using an intelligent system of self-service car rental management. User completes rental fee payment and item pickup through a smart self-service operation module, and completes vehicle verification through an on-board information collection module and a vehicle appearance inspection module, based on computer vision technology for unsupervised self-service pickup and vehicle return. The invention solves the problems of the high cost of car rental time, labor cost in today's car rental industry, and the chaotic and messy parking of cars in the stores of car rental companies, so that car rental services are more convenient, fast and civilized.

Finally, document number U.S. Ser. No. 10/037,689B2 describes a system apparatus that manages and adjusts the density and/or the speed of the monitored traffic in relation to the spatial georeferenced location flow rates, through a plurality of sensor devices of mobile and/or stationary encrypted communication, the system transmits calculated digital navigation directives through a network of domains, within any infrastructure in direct secure communication with humans, drivers and/or owners and/or vehicle transport mechanisms themselves, visible and/or audible on the iNavX2 virtual interface, which provide on-demand dimensional spatial map georeferenced location services, requests generated by the driver and/or vehicle system for certified announcements and monitoring of transmitted navigation maneuvers.

The present invention details differences in relation to the related art, specifically, in the ability it gives the user to be able to choose the driver that best suits their needs in relation to price, ratings of other users, type of vehicle required and distance between georeferenced locations. For her/his part, the driver has the possibility to set the price of services to users and pay the application for the promotion of her/his services when the driver is hired by a user.

### BRIEF DESCRIPTION OF THE DRAWINGS

FIG. 1. Diagram showing the interaction processes between the components of the system for the promotion of mobility services and logistics of goods based on advertisements.

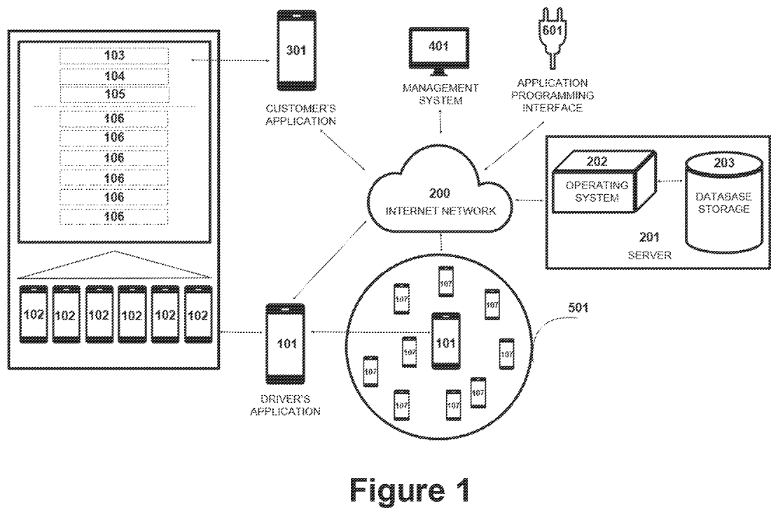

FIG. 2. Diagram showing the interaction processes between the components of the system for the promotion of mobility services and logistics of goods based on advertisements to activate SOS collective help alarms for victims who are in a situation of danger from alleged perpetrators.

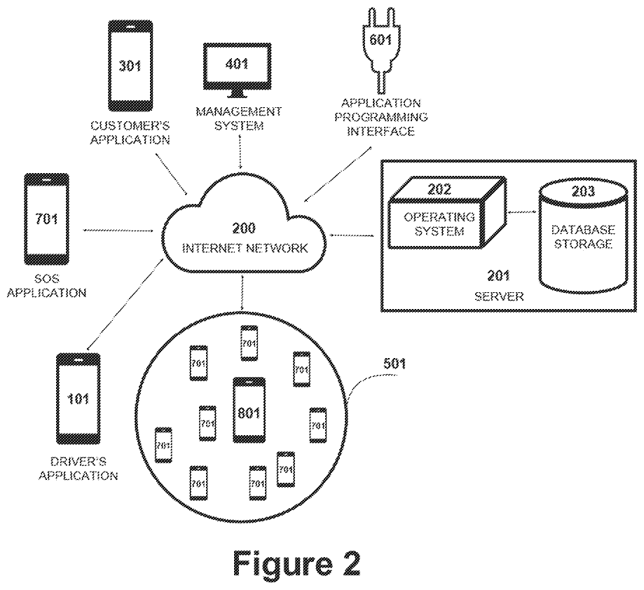

FIG. 3. Diagram showing the interaction processes between the components of the system for the promotion of mobility services and logistics of goods based on advertisements to activate SOS collective help alarms of victims who are in a situation of danger from alleged perpetrators, wherein the connection of an internal electronic commerce application is observed, so that the purchased goods can be transported by choosing the drivers by the same customers, based on the information in the advertisements of the logistics of goods services offered by the drivers.

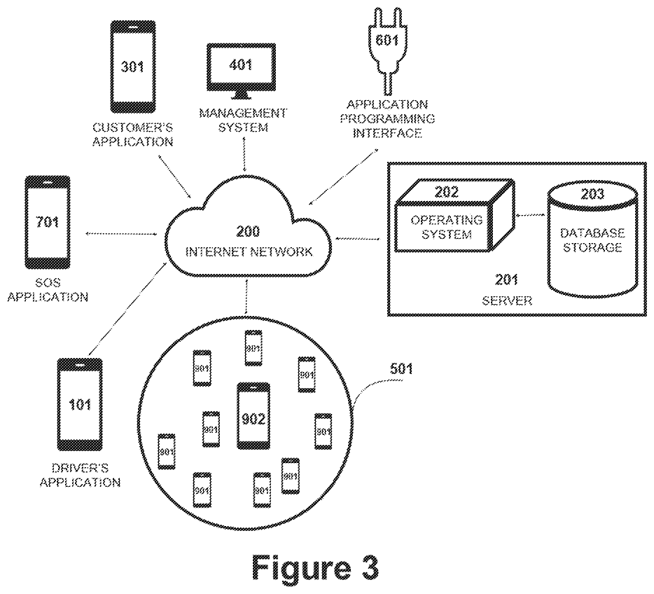

### DETAILED DESCRIPTION OF THE INVENTION

The present invention describes a system and method for the promotion of mobility services and logistics of goods based on advertisements, this system provides the customer with freedom to choose the service and the price of the service the customer wants to hire, based on a series of advertisements generated by an operating system to show the offer of the drivers, and their services for the transport of people or goods, in addition the customer is able to create her/his own community of favorite and trusted drivers to more easily hire said community of drivers when the customer requires a service; likewise, the driver and the customer can agree in advance on prices fixed between both so that the customers can hire their favorite and trusted drivers, knowing in advance how much the service will cost. This system and method allows drivers to have the absolute freedom to define the prices of their mobility services for people and logistics of goods, as well as the absolute freedom to decide how much to pay for the concept of advertisement of services with potential customers to a management system that links supply and demand.

The elements involved in the operation of the system, which are used by various users of the system, include a management system (401), a series of mobile applications: a driver's application (101), a customer's application (301) and a SOS application (701), a server (201) made up of a database storage (203) and an operating system (202), an internet network (200) and an Application Programming Interface (601). All components and the way in which they interact with each other to achieve the object of the present invention are detailed below.

System users comprise external computer systems (901), without limiting to drivers, potential customers, and system administrators. Each driver-type user is able to open a user account by downloading a driver's application (101) on her/his mobile device to validate the following user information:
Personal information of the driver.
Information about the vehicle with which the driver intends to offer services.

The driver's application (101) connects to a server (201) through the Internet network (200), to connect to an operating system (202), to proceed to validate, and to register in a database storage (203) the information captured in the driver's application (101) about her/his personal information and information of the vehicle with which the driver intends to offer services.

The driver, from her/his driver's application (101), connects to the server (201) through the Internet network (200), and sends the georeferenced data of the geographical area (102) where the driver's application (101) is in real time, which is installed on the driver's mobile device, where the operating system (202) validates said georeferenced location in real time as the place where the driver is registering, so that later the operating system (202) proceeds to validate the vehicle registered by the driver and return with the information through the Internet network (200) to show her/him in the driver's application (101) the applicable services of mobility of people, delivery of goods, and logistics that the driver can offer based on said vehicle registered by the driver, and also according to the geographical area (102) where the driver's application (101) is registered.

The operating system (202) validates on the server (201) if the driver's application (101) is in a geographical area (102) regulated by local authorities or governments where there are authorizations that the driver must have in order to offer any of the services, the driver has chosen. If this is the case, the driver sends through the driver's application (101) the information of her/his permits to the database storage (203) so that said information is saved, the information is sent through the Internet network (200) to the server (201) where the database storage (203) is located, to be later reviewed by the management system (401) that accesses the server (201) through the Internet network (200) to enter to the database storage (203) and review the driver's information so that, if approved, notify the driver to start promoting their services through advertisements (106) in the customer's application (301) that demand the services that the driver offers from their driver's application (101) to the customer market.

If the driver does not require permits from local authorities or governments, the operating system (202) allows the driver's application (101) to continue with the process so that the driver can, from the driver's application (101), promote their services through advertisements (106) in customer's application (301) who demand its services.

Each driver, from their driver's application (101), can validate different keywords related to her/his services and the vehicle with which they perform their services, where said keywords are registered in the database storage (203), and are displayed in a customer's application (301), which allows the customer to easily filter and find the driver of their choice in a search engine (104) from the interface of the customer's application (301) at the time of displaying all the advertisements (106) of the services of all the drivers that are within the geographical area (102) where the customer's application (301) is geolocated, and that offer the services that the customer is seeking to hire at that moment and were previously defined in its customer's application (301), the customer's application (301) has a filter tool (105) to control the arrangement of the offer of the “set of advertisements (106) of services of the drivers that are in the geographical area (102)” based on different editable considerations in the algorithm of the operating system (202) by the service variables that include: the price that each driver defined for their services in their driver's application (101); distance between the georeferenced location where the customer's application (301) is located with respect to the georeferenced location where the driver's application (101) is located, for mobility services, the distance between the georeferenced location where the goods to be transported must be collected defined in the customer's application (301) with respect to the georeferenced location where the driver's application (101) is located for logistics of goods services; the ratings of others customers; drivers who were previously labeled by the customer as “favorites”; among other variables so that the customer can voluntarily select the best driver option within a defined period of time which is counted by a countdown counter (103), and that when the customer from her/his customer's application (301) voluntarily hires the driver of their preference, said chosen driver is notified in her/his driver's application (101) that the customer has chosen her/him and wishes to hire her/him for the service, by showing the driver in her/his driver's application (101) the details of the service as customer information, origin and destination, and in the case of logistics services the details of the goods to be transported, this in order for the driver to agree to provide the service which can be immediate or by reservation at a certain time and day, or the driver can also refuse or not accept to give said service to said customer from the driver's application (101), where in any of the cases, either accepted or rejected, the operating system (202) sends a notification to the customer's application (301) of the decision made by the driver and validated in her/his driver's application (101).

When all the advertisements (106) displayed to promote mobility services and logistics of goods are displayed for the first time for all drivers who are within the geographical area (102), where the customer's application (301) is geolocated, and that offer the services that the customer is looking to hire at that moment and that the customer previously requested in her/his customer's application (301), the algorithm of the operating system (202) shows in the customer's application (301) a first version of advertisements (106) giving preference to those advertisements in different editable considerations in the algorithm of the operating system (202) to the display preference variables: (1) drivers who have verified their identity and vehicle with personal information and information on the vehicle with which the driver intends to offer services; (2) drivers who in their driver's application (101) defined paying more to the operating system (202) for promoting their advertisements (106) in customer's applications (301) with respect to their competitors; (3) drivers who in their driver's application (101) defined to buy a membership to have a better preference for their advertisements (106) in customer's applications (301); (4) drivers who in their driver's application (101) defined giving a better price to customers for their services compared to their competitors; (5) the driver's applications (101) that are closest to the hiring customer in terms of geolocation and the equivalent time to reach the georeferenced location where the hiring customer's applications (301) is located or the georeferenced location where the goods to be transported must be collected; (6) the driver's applications (101) that have the best ratings by the entire community of customers who have previously hired them; (7) among other variables that give weighting value, and that are part of the algorithm that defines the position of each advertisement (106) of the services of each driver deployed in the customer's applications (301) contracting as part of the set of applications of available drivers who advertise their services to a specific customer.

From the moment each driver opens their account in their respective driver's application (101) they can define, change and adjust their own prices, the ones that they wish to charge for their services to the customers, where the price of their services appear in the customer's applications (301) in the respective advertisements (106) of their services, where at any time each driver from their driver's application (101) can update their prices where this information is transmitted through the Internet network (200) in real time and processed by the operating system (202) to save said information in the database storage (203), and that the operating system (202) can charge said predefined prices to the driver's customers at the end of each service hired by the customers.

When a driver wants to define, change and adjust her/his own prices that wants to charge for her/his services to the customers, based on different variables, each driver in her/his driver's application (101) can see the average of the prices that the competing drivers are offering for similar services and with vehicles similar to that of the driver who wishes to define, change and adjust their own prices, where the driver from her/his driver's application (101) can also define the distance of the circumference (501) around the geolocation where its driver's application (101) is found, to connect through the Internet network (200) to the server (201) where the operating system (202) and the database storage (203) are hosted in order to identify all the competing drivers that are within the circumference (501), where their driver's application (101) is located and thus be able to process the mathematical calculation of the average or of the prices that all applicable competing drivers are offering within the desired calculation circumference (501).

Each driver in her/his respective driver's application (101) can define, change and adjust the payment the driver wishes to pay to the management system (401) for the concept of promoting her/his advertisements (106) before the audience of potential customers, where said advertisements (106) are shown in customer's applications (301) who wish to hire a service similar to the one that the driver is offering through her/his driver's application (101), where the higher the payment that a driver agrees to pay through of her/his driver's application (101) for the promotion of her/his advertisements (106) before the audience of potential customers, her/his advertisements will be in a better position with respect to the other advertisements (106) of the rest of the competing drivers, where at any time each driver from her/his driver's application (101) can update the amount the driver wishes to pay to the platform for the promotion of her/his advertisements (106), where this information on the amount to be paid is transmitted through the Internet network (200) in real time and processed by the operating system (202) to be stored in the database storage (203), and that the operating system (202) can collect said predefined payments to the respective drivers at the end of each service they give to a customer.

When a driver wants to define, change and adjust the amount that wants to pay the platform for promoting the advertisements (106) of her/his services to potential customers, each driver in her/his driver's application (101) can see the average of the amounts that the competing drivers are offering to pay to the management system (401) for similar services and with vehicles that are similar to that of the driver who wishes to define, change and adjust their amounts to be paid for the promotion of advertisements (106), where the driver from her/his driver's application (101) can also define the distance of the circumference (501) around the geolocation where her/his driver's application (101) is georeferenced located, to connect through the Internet network (200) to the server (201) where the operating system (202) and the database storage (203) are hosted to be able to identify all the competing drivers that are within the circumference \ (501) where its driver's application (101) is georeferenced located, and thus be able to process the mathematical calculation of the average of the amounts that all applicable competing drivers are offering to pay to the platform within the desired calculation circumference (501).

When a customer wishes to hire a service through her/his customer's application (301), the customer defines what type of service wishes to hire and what type of vehicle needs for said service, and validates to connect through the Internet network (200) to the server (201) and from the operating system (202) to the server (202), and to be able to show the customer in its customer's application (301) all the advertisements (106), with the offers of the drivers that are within the geographical area (102) from where the customer's application (301) is georeferenced located, where said advertisements (106) are shown to customers under an algorithm that integrates different mathematical variables defined above, where once all the advertisements (106) of the drivers in the area are displayed, the customer, from her/his customer's application (301) selects the one that best suits her/his needs.

In the display interface of the customer's application (301) the advertisements (106) of the drivers can be filtered based on keywords related to the services and vehicles of each driver, or the advertisements (106) of the drivers can be filtered based on different variables defined as: price of the service; distance, taking into account the distance between the customer's georeferenced location and the georeferenced location of each driver, or for goods logistics services, taking into account the geolocation of the place where the driver should collect the goods to be transported and the real time georeferenced location of each driver's application (101); the time it takes for each driver to arrive, taking into account the distances between the customer and each driver and traffic conditions at that time; the ratings and comments of other customers about the services of drivers; number of customers who have chosen the driver as a favorite; as well as filtering the advertisements (106) of the drivers to see only the advertisements (106) of the drivers who are the customer's favorites and with whom they have previously agreed on special prices.

When the customer, in her/his customer's application (301), chooses the driver the customer wishes to hire by validating in the advertisement (106) of said driver, where the customer ignores the other advertisements (106) shown from the other drivers, the customer's application (301) connects to the server (201) and the operating system (202) to notify the driver's application (101) that it has been chosen by the customer showing the details of the service so that the driver can accept or refuse to provide the service.

Whether the driver accepts or rejects the service from her/his driver's application (101), the application of the customer (301) who contracted the service is notified by communicating through the Internet network (200) to the Server (201) and the operating system (202).

If the driver agrees to provide the service by making the respective validation from her/his driver's application (101), the operating system (202) charges the customer through the payment method registered by the customer in her/his customer's application (301) for the amount of the price previously defined by the driver, and that was published in the advertisement (106), that the customer agreed to pay for the service hired at the moment the driver validates in her/his driver's application (101) that the service has already been successfully completed satisfying the need for the service hired by the customer. In mobility services, if the customer requests to change routes, or make multiple stops, or the conditions of the service change, it is possible that the final price that the customer has to pay changes, which will be automatically adjusted according to the variables of the price that the driver defined in her/his driver's application (101); in the same way, for logistics of goods services, before starting the service, the driver and the customer can renegotiate the final price of the service, so the driver from her/his driver's application (101) can adjust the new price agreed between the driver and the customer which is accepted by the customer in her/his customer's application (301), so that the driver can start the logistics of goods service in her/his driver's application (101).

At the end of each service that each customer hires in their customer's application (301), they can validate the driver's application (101) as a “Favorite”, where the driver's application (101) will be now registered in the database storage (203) as a “Favorite” driver of the customer's application (301), the customer's applications (301) and driver's application (101) communicating through Internet network (200) with the server (201) and the operating system (202) being registered in the database storage (203) and that in the respective sections of “Favorites” of the customer's applications (301) and the driver's application (101) it appears that this link exists and that they are “Favorites”, wherein said “Favorites” section in the customer's application (301) there is a search engine (104) where the customer can easily find any driver's application (101) by typing the driver's first and last name, keywords that the driver has validated so that the driver can be easily find, the driver's user number, or scan a QR code generated by the operating system (202) to identify the driver, in order to validate her/him as a “Favorites” driver without requiring to have previously contracted their services. At any time, both the driver from their driver's application (101) and the customer from their customer's application (301) can cancel this “Favorites” link that allows customers to easily locate their community of trusted drivers and that is why they have been validated as “Favorites”, and that also allows drivers from their driver's application (101) to give special prices and fixed prices to their customers who have validated them as “Favorite”, so that when a customer from her/his customer's application (301) wishes to hire a service in the advertisements (106) the special prices and/or fixed prices previously agreed by the driver through her/his driver's application (101) and with each of her/his customers appear linking said special prices and/or fixed prices with the respective customer's application (301), being this information about special prices and/or fixed prices defined for each customer, registered in the database storage (203). If the driver in her/his driver's application (101) decides to cancel or change the special prices previously agreed with a customer, when canceling or changing the special prices a connection is made to the server (201), to the operating system (202) and to the database storage (203) through the Internet network (200) to cancel or adjust the special prices of said customer by notifying the customer's application (301) in question. Similarly, if a customer decides to remove a driver from favorites along with their special rates or to block it permanently, a connection is made to the server (201), the operating system (202) and the database storage (203) through the Internet network (200) to update this information and the driver is notified in her/his driver's application (101).

The system also has an Application Programming Interface (601) algorithm with the functionality that customers can connect their customer's application (301) account to other external computer systems such as Mobile Applications, Web Pages, Servers, Electronic commerce platforms, among other external computer systems, where the connection to the server (201), the operating system (202) and the database storage (203) is through the Internet network (200), in order to connect the account of the customer linked to their customer's application (301) and thus each customer can have the ability to automatically hire their community of favorite drivers, as well as non-favorite drivers through the algorithm of the Application Programming Interface (601) to connect with the respective driver's applications (101), and be able to automatically contract the logistics and goods delivery services offered by said drivers, where the Application Programming Interface (601) algorithm gives priority in the process of choosing and hiring drivers automatically to those driver's applications (101) that are validated as “Favorites” by the hiring customer's application (301), and have special and/or fixed prices predetermined between the driver's application (101) and the customer's application (301), and that the georeferenced location of the driver's applications (101) are closer to the georeferenced location for the collection of the goods to be transported, and if there are no favorite driver's applications (101) available at that time, the algorithm of the Application Programming Interface (601) then proceeds to automatically choose to hire the driver's application (101) that is closer to the georeferenced location for the collection of the goods to be transported, with a better rating by the customer community and the driver's application (101) that offers the cheapest price defined by the same driver in her/his driver's application (101).

The Application Programming Interface (601) algorithm has the configuration to activate the functionality that allows customers to connect their customer's application (301) account to other external computer systems (901) such as Mobile Applications, Web Pages, Servers, e-commerce platforms, among other external computer systems, where the connection to the server (201) and the operating system (202) and the database storage (203) is through the Internet network (200), for so that any person who buys any promoted good through the external computer systems (901) connected by the Application Programming Interface (601) through the Internet network (200) can see the advertisements (106) of the drivers and freely choose to hire the best driver option, based on the prices offered by each driver, which were defined in the respective driver's application (101), as well as by the ratings that other customers have validated on each driver through their customer's applications (301), the closest distance in terms of geolocation between the location where the goods to be transported must be collected and the georeferenced location where each driver's application (101) that could provide the service is georeferenced located at that real time, as well as being able to filter the advertisements (106) of the drivers that are favorites of the customer who wishes to freely choose to hire the best driver option, where the customer validates the accesses of her/his account of customer to connect to the server (201) and to the operating system (202) and to the database storage (203) through the Internet network (200), so that the advertisement (106) options of the drivers that are shown, are those that the customer has previously validated as favorites and, where appropriate, with those favorite drivers with whom special prices and/or fixed prices have already been established so that the chosen drivers can transport the goods that the customer buys on different external electronic commerce platforms connected to external computer systems (901), including the internal electronic commerce application (902) integrated within the customer's applications (301) where it has the ability to validate and define the circumference (501) distance of the georeferenced location from where the location where the purchased goods to be transported must be collected in real time with respect to each driver's application (101).

Users who have registered in the operating system (202) and in the database storage (203), through the driver's application (101), or, through the customer's application (301), can access an SOS application (701) with their unique user and password accesses of their respective applications, where the SOS application (701) sends distress signals that are received in a SOS community help alarm repository (801) to view the SOS community help of users who are in a situation of danger, said SOS community help alarm repository (801) is integrated into the customer's application (301), driver's application (101) and the SOS application (701), likewise the SOS community help alarm repository (801) can be connected to any external computing device through the Application Programming Interface (601) and is activated or deactivated at the user's discretion to receive auxiliary SOS alarms in real time from the victim users, or not to receive such SOS distress alarms.

The SOS community help alarm repository (801) can validate and define the distance of the circumference (501) with respect to the georeferenced location of where any of the applications is georeferenced located in real time, as well as the computing device connected to the Application Programming Interface (601). Any of the users can activate the distress signal of the SOS application (701) since it is linked to the driver's application (101) and to the customer's application (301), where the signal is sent through the Internet network (200) to the server (201) and the operating system (202), said signal is recorded in the database storage (203) and sent in real time to the SOS community help alarm repository (801) for the display of all users who have the action activated.

The system uses the following method to achieve the promotion of mobility services and logistics of goods based on advertisements, that comprises: entering from a mobile device in a driver's application (101) data of a driver type user and georeferenced data of a geographical area (102), connecting to a server (201) through the Internet network (200) to connect to an operating system (202) and validate and register the captured information in a database storage (203) in the driver's application (101) of the personal information and information of the vehicle with which the driver intends to offer a service, validate through the operating system (202) the information received by the driver's application (101) and send the validation through the Internet network (200) to show in the driver's application (101) the applicable services of mobility of people, delivery of goods, and logistics that the driver can offer, input from a mobile device in a driver's application (101) different keywords related to services and the vehicle with which they perform services, send the keywords through the server (201) and register them in the database storage (203), send the keywords through the Internet network (200) to a customer's application (301) to be viewed by a customer-type user, filter and select the driver of preference from the customer's application (301) in a search engine (104) within the interface of the customer's application (301), to display through the operating system (201) a series of advertisements (106) of the services of all the drivers that are within a geographical area (102) where the customer's application (301) is geolocated, and that offer the services that the customer is seeking to hire at that moment, control the arrangement of the offer of the set of advertisements (106) of services of the drivers that are in the geographical area (102) based on service variables within a defined period of time which is counted by means of a countdown counter (103) in the customer's application (301) through a filter tool (105), hire the preferred driver from the customer's application (301) and notify through the driver's application (101) that the customer chose her/him and wishes to hire her/him for a service, show to the driver in the driver's application (101) the details of the service for which the driver was selected and accept or refuse to provide the service from the driver's application (101), where in any of the cases it is either accepted or rejected, the operating system (202) sends a notification to the customer's application (301) of the decision made by the driver and validated in her/his driver's application (101), order the advertisements (106) based on different editable considerations in the algorithm of an operating system (202), define the price to be charged for a service through an average of prices where the distance of a circumference (501) is defined around the geolocation where a driver is geolocated through the driver's application (101), connect through the Internet network (200) to the server (201) where the operating system (202) and the database storage (203) are hosted to identify all competing drivers with similar vehicles and offering similar services that are within the circumference (501) and process the mathematical calculation of the average prices offered by all applicable competing drivers within of the circumference (501) and define, change and/or adjust the price to be charged for the service and the payment to be made to a management system (401) for the concept of service and promotion of advertisements (106) in customer's applications (301), send information on the amount to be paid through the Internet network (200) in real time, process by the operating system (202), save in the database storage (203) and collect the payment by the operating system (202) at the end of each service that a driver gives to a customer, at the end of each service that each customer hires in their customer's application (301), validate the driver's application (101) as a “Favorite”, register the validation of “Favorite” in the database storage (203) that the driver's application (101) in question is now a “Favorite” driver of the customer's application (301) communicating the customer's application (301) and the driver's application (101) through the Internet network (200) with the server (201) and the operating system (202) and register in the database storage (203), connect the customer's application account (301) or the driver's application (101) account through an Application Programming Interface (601) to other external computer systems (901) such as mobile applications, web pages, servers, electronic commerce platforms, among other external computer systems, including the internal electronic commerce application (902) integrated within the customer's applications (301), where the connection of the Application Programming Interface (601) to the server (201), the operating system (202) and the database storage (203) is through the Internet network (200) to connect the customer account linked to its customer's application (301) and thus contract manually or automatically to their community of “Favorite” drivers, access an SOS application (701) with the unique username and password of the driver's application (101), or, through the customer's application (301), and send distress signals when a dangerous situation arises through the Internet network (200) to the server (201) and the operating system (202), and register in the database storage (203), send in real time distress signal to an SOS community help alarm repository (801) that is displayed in the customer's application (301), in the driver's application (101), in the SOS application (701) and in external computer equipment connected through the Application Programming Interface (601).

### Examples of Use

### Drivers' Prioritization in the Driver's Application.

The operating system (202) defines the priority of each advertisement (106), giving preference to the universe of advertisements (106) in different editable weights in the operating system (202) algorithm, in order to define the indicated position of each advertisement (106) to be displayed in each customer's application (301) of potential customers, or also to potential customers who are interacting on external or internal e-commerce platforms connected through the Internet network (200) to the server (201) and to the operating system (202) through external computer systems (901), or potential customers who are interacting through an internal e-commerce application (902), considering different variables such as the price that each driver has personally defined through his driver's application (101), for his/her services of mobility of people and/or logistics of goods, the price that each driver has personally defined to pay to an administrative system (401) for the concept of promoting his/her advertisements (106) to the audience of potential customers, where such advertisements (106) are displayed in the customer's applications (301), external computer systems (901) and internal e-commerce application (902), to be shown to an audience of potential customers who wish to hire a service similar to the one the driver is offering through his/her driver's application (101), the distance of the location of the geographical area (102) defined by geolocation of each driver with respect to the location defined by geolocation of each potential customer to whom the advertisements (106) are shown, the operating system (202) also considers the ratings that customers have previously left of each driver for the quality of their services, the type of vehicle operated by the drivers, the brand and model of the vehicle in case these data are relevant to the customer, less polluting vehicles or with zero emissions of polluting gases in case this variable is relevant for the customer, it also considers drivers who have been rated by each customer in particular as “Favorites” because they have validated that there are links of trust between customer and driver, the operating system (202) also considers in the arrangement of the advertisements (106) those drivers who have granted predefined fixed prices agreed between the driver and each of her/his different customers to whom the advertisements (106) of the supply of drivers available in the area are shown, including those drivers who have agreed to collaborate exclusively with some of their customers for certain periods of time, where drivers validate in their driver's application (101) that they voluntarily wish to provide their services exclusively to a certain customer's application (301) during a certain time validating the date and time of start and expiration of the exclusive service, so that when the exclusivity period expires again, the operating system (202) proceeds to promote its advertisements (106) again within the geographical area (102) to the rest of the customer users in their respective customer's applications (301), the operating system (202) even considers the certifications that each driver has to validate their identity, both the validations granted by the governing platform, as well as the identity validations that the customer community itself gives to each driver, everything so that the customer community as a whole can have the freedom to choose and hire their best driver option for their needs in mobility and logistics of goods.

Each driver, in their respective driver's application (101), can define, change and adjust the prices that they want to charge for their services to their customers, based on different variables, where the price of their services appears in the customer's application (301) in the respective advertisements (106) of their services, where at any time each driver from their driver's application (101) can update their prices based on different variables that can be, but are not limited to, fixed prices, and/or variable prices that are calculated in real time, based on the time and distance traveled from each service from what each customer has defined in their respective customer's application (301) depending on the origin and destination of each service that each customer intends to hire, where the operating system (202) calculates the distance in terms of geolocation and the equivalent time to reach the location where the application of the contracting customer is located or the location where the goods to be transported must be collected, according to real time traffic variables, in order to show, in a personalized and unique way, to each customer, in their respective customer application (301), external computer systems (901) and internal electronic commerce application (902), advertisements (106) with the calculated and specific prices for each customer, so that they can choose and hire the driver of their preference.

### SOS Alarm Signal Activation

In the scenario where the driver is the perpetrators and the customer the victim, and the customer in her/his customer's application (301) activates the SOS alarm from the SOS application (701), then the signal is sent through the Internet network (200) to the server (201) and to the operating system (202) that said customer that operates the customer's application (301) is in a dangerous situation with the driver that operates the driver's application (101) where it is registered in the database storage (203) that said driver's application (101) and the customer's application (301) are the perpetrators and the victim respectively, and the operating system (202) sends the alarm signal in real time to all those SOS community help alarm repositories (801) that are activated at that time and that the georeferenced location of the customer's application (301) labeled as victim is within the circumference (501) defined by each of the SOS community help alarm repositories (801) of SOS or help alarms, where the SOS alarm is excluded from the SOS community help alarm repositories (801) of SOS alarms that is installed within the driver's application (101) labeled as perpetrators so that the driver does not find out that the customer triggered the SOS or help alarm.

In all SOS community help alarm repositories (801) of SOS alarms that received the distress signal from the customer's application (301) as a victim, they can see the following: (1) real-time location of the customer's application (301) as victim, moving the location in real time on a digital map, the first and last name of the customer and her/his user photograph; (2) real-time location of the driver's application (101) as the perpetrators, moving the location in real time on a digital map, the driver's first and last name, her/his user photo, vehicle data, vehicle license plates, photograph of the vehicle; (3) button to validate agreeing to help the victim; (4) button to validate, ignore or refuse to help the victim.

If the user decides to validate from her/his driver's application (101), customer's application (301), SOS application (701) or from the computing device connected to the Application Programming Interface (601) the button to accept helping the victim which is within the SOS community help alarm repositories (801), the signal is sent to the respective customer's application (301) of the victim in question through the Internet network (200) that was previously processed on the server (201) where the operating system (202) is located and being registered in the database storage (203) that said user decided to help, in order to return the information to the customer's application (301), in a victim situation, giving the news that the user in question is already on her/his way to her/his georeferenced location because the user agreed to help, where in the customer's application (301), in a victim situation, a counter appears that shows all the users who have agreed to help with their respective names, and on the other hand, all users who agreed to help in their respective SOS community help alarm repositories (801) of SOS alarms can see the following at all times during the help process: (1) real-time location of customer's application (301) as victim moving the geolocation in real time on a digital map, the first and last name of the customer and her/his user photograph; (2) real-time geolocation of the driver's application (101) as the perpetrators, with the real-time moving geolocation on a digital map, the driver's first and last name, her/his user photograph, vehicle data, vehicle plates, photograph of the vehicle; (3) the real-time transmission of audio and video captured and processed from the driver's application (101) and the customer's application (301) which is sent in two different information channels through the Internet network (200) to the server (201) and processed operating system (202), where all the audio and video information is processed over time, linking each microsecond of the received audio and video information to the georeferenced location of the device where said information was captured and all the audio and video information from both the driver's application (101) and the customer's application (301) being recorded in the database storage (203) at the same time that the audio and video information is transmitted to the driver's application (101), customer's application (301) and SOS application (701) of the users who are at a certain close distance to the device of the victim and perpetrator; (4) button so that the victim can view and download the recorded video as legal evidence from the database storage (203) to any device or send through the Internet network (200) to any server or email account; (5) button in the driver's application (101) and in the customer's application (301) so that if they are victims and have to activate the SOS alarm to request help, the video is not transmitted in real time with the entire community and only it is saved in the database storage (203) for later viewing and downloading the video at any time; and (6) button to cancel help to the victim, which is informed to the victim if this button is validated.

In the scenario where the driver is the victim and the customer the perpetrators, and the driver in her/his driver's application (101) activates the community SOS alarm in the SOS application (701), then the signal is sent through the Internet network (200) to the server (201) and to the operating system (202) that said driver that operates the driver's application (101) is in a dangerous situation with the customer that operates the customer's application (301) where it is registered in the database storage (203) that said customer's application (301) and the driver's application (101) are the perpetrators and the victim respectively and the operating system sends the alarm signal in real time to all those SOS community help alarm repositories (801) that are activated at that moment and that the geolocation of the driver's application (101) as the victim is within the circumference (501) defined by each of the SOS community help alarm repositories (801) of SOS alarms, where the SOS alarm is excluded from the SOS community help alarm repository (801) of SOS alarms that is installed within the customer's application (301) labeled as perpetrators so that the customer does not find out that the driver activated the SOS alarm.

In all SOS community help alarm repositories (801) of SOS alarms that received the distress signal from the driver's application (101) as a victim, they can see the following: (1) real-time geolocation of the driver's application (101) as a victim with the real-time moving geolocation on a digital map, the driver's first and last name, her/his user photograph, vehicle data, vehicle plates, vehicle photograph; (2) real-time geolocation of the customer's application (101) as perpetrators, with the real-time moving geolocation on a digital map, the customer's first and last name and her/his user photograph; (3) button to validate agree to help the victim; (4) button to validate, ignore or refuse to help the victim.

If the user decides to validate from her/his driver's application (101), customer's application (301), SOS application (701) or from the computing device connected to the Application Programming Interface (601) the button to accept help the victim which is within the SOS community help alarm repositories (801), the signal is sent to the victim in question to their respective driver's application (101) through the Internet network (200) that was previously processed on the server (201) where the operating system (202) is located and being registered in the database storage (203) that said user decided to help, in order to return with the information to the driver's application (101) of the victim driver giving the news that the user in question is already on her/his way to her/his georeferenced location because the user agreed to help, where in the driver's application (101), in a victim situation, a counter appears that shows all the users who have accepted to help with their respective names, and on the other hand, all users who agreed to help in their respective SOS community help alarm repositories (801) can see the following at all times during the help process: (1) geolocation in real time of the driver's application (101) as victim with the real-time moving geolocation on a digital map, the driver's first and last name, her/his user photograph, vehicle data, vehicle plates, vehicle photograph; (2) real-time geolocation of the customer's application (101) as a perpetrators, moving the geolocation in real time on a digital map, the customer's first and last name and her/his user photograph; (3) button to cancel helping the victim, which is informed to the victim if this button is validated.

Having sufficiently described my invention, I consider as a novelty and therefore claim as my exclusive property, what is contained in the following claims:

1. A server configured to:
receive a first alarm signal from a first mobile device;
determine a first geolocation of the first mobile device;
identify a second mobile device associated with the first mobile device;
determine a second geolocation of the second mobile device identify a plurality of third mobile devices located within a threshold distance of the first geolocation of the first mobile device; and
transmit a second alarm signal to each mobile device among the plurality of third mobile devices other than the second mobile device.

2. The server according to claim 1, wherein the first mobile device is associated with a driver of a vehicle, and the second mobile device is associated with a passenger of the vehicle.

3. The server according to claim 1, wherein the second mobile device is associated with a driver of a vehicle, and the first mobile device is associated with a passenger of the vehicle.

4. The server according to claim 1, wherein the second alarm signal identifies the first geolocation of the first mobile device and the second geolocation of the second mobile device.

5. The server according to claim 1, wherein the second alarm signal identifies a name of a first user associated with the first mobile device and a name of a second user associated with the second mobile device.

6. The server according to claim 1, wherein the second alarm signal includes a first picture of a first user associated with the first mobile device and a second picture of a second user associated with the second mobile device.

7. The server according to claim 1, wherein the second alarm signal includes information about a vehicle associated with the first mobile device and the second mobile device.

8. The server according to claim 1, further configured to:
receive a first response to the second alarm signal from at least one of the third mobile devices; and
transmit a second response signal to the first mobile device.

9. The server according to claim 8, wherein the second response signal comprises information about a user associated with the at least one of the third mobile devices.

10. The server according to claim 1, further configured to receive audio, in real time, recorded by the first mobile device and to store the audio.

11. The server according to claim 1, further configured to receive video, in real time, recorded by the first mobile device and to store the video.

12. The server according to claim 1, further configured to receive, in real time, the first geolocation data and the second geolocation data, and to store the first geolocation data and the second geolocation data.

13. A method comprising:
receiving a first alarm signal from a first mobile device;
determining a first geolocation of the first mobile device;
identifying a second mobile device associated with the first mobile device;
determining a second geolocation of the second mobile device identifying a plurality of third mobile devices located within a threshold distance of the first geolocation of the first mobile device; and
transmitting a second alarm signal to each mobile device among the plurality of third mobile devices other than the second mobile device.

14. The method according to claim 13, wherein the first mobile device is associated with a driver of a vehicle, and the second mobile device is associated with a passenger of the vehicle.

15. The method according to claim 13, wherein the second mobile device is associated with a driver of a vehicle, and the first mobile device is associated with a passenger of the vehicle.

16. The method according to claim 13, wherein the second alarm signal identifies the first geolocation of the first mobile device and the second geolocation of the second mobile device.

17. The method according to claim 13, further comprising:
receiving a first response to the second alarm signal from at least one of the third mobile devices; and
transmitting a second response signal to the first mobile device.

18. The method according to claim 17, wherein the second response signal comprises information about a user associated with the at least one of the third mobile devices.

19. The method according to claim 18, further configured to receive audio and/or video, in real time, recorded by the first mobile device; and to store the audio and/or video.

20. A system comprising:
a server; and
a plurality of mobile devices;
wherein the server is configured to:
receive a first alarm signal from a first mobile device among the plurality of mobile devices;
determine a first geolocation of the first mobile device;
identify a second mobile device among the plurality of mobile devices associated with the first mobile device;
determine a second geolocation of the second mobile device;
identify a plurality of third mobile devices among the plurality of mobile devices located within a threshold distance of the first geolocation of the first mobile device; and
transmit a second alarm signal to each mobile device among the plurality of third mobile devices other than the second mobile device.
